(19) United States
(12) Patent Application Publication
(10) Pub. No.: US 2025/0371490 A1
(43) Pub. Date: Dec. 4, 2025

(54) PREDICTING USER LOCATION DURING AN ATTENDED DELIVERY USING A MACHINE LEARNED MODEL

(71) Applicant: Maplebear Inc., San Francisco, CA (US)

(72) Inventors: Annie Zhang, Gardena, CA (US); Christopher Billman, Chicago, IL (US); Radhika Anand, Redwood City, CA (US); Adam Vanderpool, Fort Worth, TX (US); Sai Kannan Sampath, Berkeley, CA (US); Zirui Zhong, San Jose, CA (US); Kenneth Jason Sanchez, Orange, CA (US)

(21) Appl. No.: 18/677,770

(22) Filed: May 29, 2024

(51) Int. Cl. G06Q 10/083; G06Q 10/0832

(52) U.S. Cl. CPC G06Q 10/0838; G06Q 10/0832

(57) ABSTRACT

An online system predicts whether a user will be at a delivery location at a delivery time for an attended delivery of an order using a machine-learned model. The online system receives the order from a client device of a user and a request by the user for an attended delivery of the order where the user will be at the delivery location at the delivery time of the order. The machine-learned model predicts that the user will not be at the delivery location at the delivery time based on user attributes of the user and order attributes of the order that are input into the machine-learned model. The online system performs a remedial action including transmitting a notification to the client device of the user to provide additional instructions for the attended delivery responsive to the determination that the user is not likely to be at the delivery location.

### BACKGROUND

An online system is an online platform that connects users and retailers. A user can place an order for purchasing items from participating retailers via the online system, with the shopping being done by a personal shopper. During placement of the order, the user may specify an “attended” delivery, where the user is physically present at a delivery location to receive the order from the personal shopper. After the personal shopper finishes shopping, the items are delivered to the delivery location. However, the user may not be physically present to receive the order at the delivery location when the personal shopper arrives to deliver the items despite the user specifying an attended delivery during placement of the order. This can result in the personal shopper having to wait additional time to complete the attended delivery of the order or burden the personal shopper to decide whether to leave the order unattended at the delivery location.

### SUMMARY

In accordance with one or more aspects of the disclosure, an online system predicts, using a machine-learned model, a likelihood that a user will be present at a delivery location for an attended delivery of an order, thereby successfully completing the attended delivery. In one or more embodiments, the online system receives the order from a client device of a user and a request by the user for an attended delivery of the order where the user will be present at the delivery location during delivery of the order. The machine-learned model predicts whether the user will be at the delivery location during a time window for the delivery (i.e., whether the attended delivery of the order will be successful) based on user attributes of the user and order attributes of the order that are input into the machine-learned model.

In one or more embodiments, a prediction that the attended delivery will be successful indicates a high likelihood that the user will be present to receive the order from a picker in-person at the delivery location whereas a prediction that the attended delivery will be unsuccessful indicates a low likelihood that the user will be present at the delivery location to receive the order. The online system performs a remedial action responsive to the machine-learned model predicting the attended delivery will be unsuccessful. The remedial action increases a likelihood of success of the attended delivery or may reduce a risk to the picker due to the user not being available to receive the order in-person. Thus, the online system relieves burden on the picker from having to decide whether to wait for the user at the delivery location to complete the attended delivery or leave the order unattended at the delivery location.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 is an example user interface to select an unattended delivery or attended delivery for a user's order, in accordance with one or more embodiments.

FIG. 4 is an example user interface of a remedial action to change an order from an attended delivery to an unattended delivery, in accordance with one or more embodiments.

FIG. 5 is an example user interface of a remedial action requesting contact information of a user that will receive the attended delivery of the user's order, in accordance with one or more embodiments.

FIG. 6 is an example user interface of a remedial action requesting contact information of another user that will receive the attended delivery of the user's order, in accordance with one or more embodiments.

FIG. 7 is a diagram illustrating a timeline for delivering a user's order during which one or more remedial actions are performed to increase a likelihood of success of an attended delivery of the user's order, in accordance with one or more embodiments.

FIG. 8 is a flowchart for delivering a user's order, in accordance with one or more embodiments.

### DETAILED DESCRIPTION

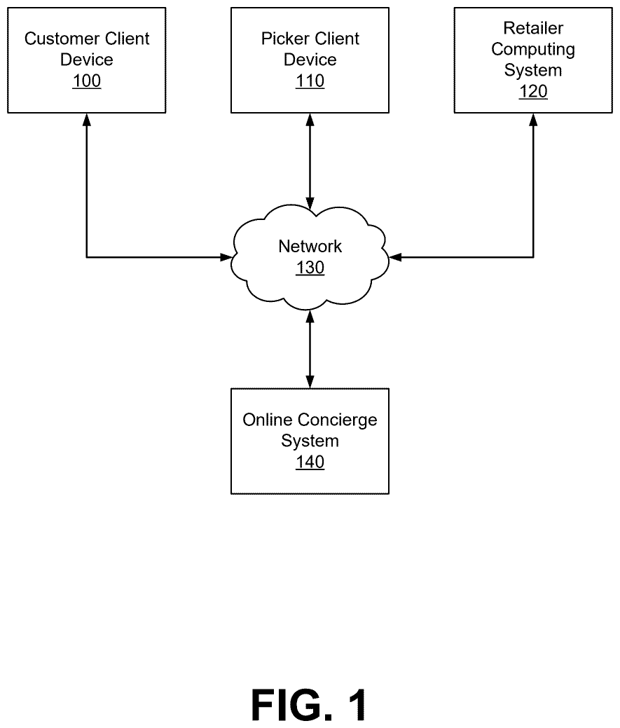

FIG. 1 illustrates an example system environment for an online concierge system 140, in accordance with one or more embodiments. The system environment illustrated in FIG. 1 includes a user client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and retailer computing system 120 are illustrated in FIG. 1, any number of users, pickers, and retailers may interact with the online concierge system 140. As such, there may be more than one user client device 100, picker client device 110, or retailer computing system 120.

The user client device 100 is a client device through which a user may interact with the picker client device 110, the retailer computing system 120, or the online concierge system 140. The user client device 100 can be a personal or mobile computing device, such as a smartphone, a tablet, a laptop computer, or desktop computer. In some embodiments, the user client device 100 executes a client application that uses an application programming interface (API) to communicate with the online concierge system 140.

A user uses the user client device 100 to place an order with the online concierge system 140. An order specifies a set of items to be delivered to the user. An “item,” as used herein, means a good or product that can be provided to the user through the online concierge system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. The order may also include an indication of a selection by the user of an “attended” delivery option where the user is physically present to receive the order from the picker at the delivery location at a delivery time for the order or an “unattended” delivery option where the user is not physically present at the delivery location to receive the order from the picker at the delivery time. During an unattended delivery, the picker leaves the order at the delivery location, such as at the front door of the delivery location. In some embodiments, the order also specifies one or more retailers from which the ordered items should be collected.

The user client device 100 presents an ordering interface to the user. The ordering interface is a user interface that the user can use to place an order with the online concierge system 140. The ordering interface may be part of a client application operating on the user client device 100. The ordering interface allows the user to search for items that are available through the online concierge system 140 and the user can select which items to add to a “shopping list.” A “shopping list,” as used herein, is a tentative set of items that the user has selected for an order but that has not yet been finalized for an order. The ordering interface allows a user to update the shopping list, e.g., by changing the quantity of items, adding or removing items, or adding instructions for items that specify how the item should be collected. The ordering interface also provides an option to the user for an attended delivery or an unattended delivery of the order.

The user client device 100 may receive additional content from the online concierge system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online concierge system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker (e.g., a delivery agent or personal shopper) may interact with the user client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same retailer location. The collection interface further presents instructions that the user may have included related to the collection of items in the order. Additionally, the collection interface may present a location of each item at the retailer, and may even specify a sequence in which the picker should collect the items for improved efficiency in collecting items. In some embodiments, the picker client device 110 transmits to the online concierge system 140 or the user client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a user's order. For example, the picker client device 110 displays a delivery location from the order to the picker and whether the order will be delivered using an attended delivery or an unattended delivery. The picker client device 110 also provides navigation instructions for the picker to travel from the retailer location to the delivery location. When a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the user client device 100 for display to the user, so that the user can keep track of when their order will be delivered. The picker client device 110 may also track the time spent from arrival at the delivery location to departure of the delivery location for an attended delivery. The tracked time indicates the amount of time required by the picker to complete the attended delivery of the order. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi-or fully-autonomous robot may collect items in a retailer location for an order and an autonomous vehicle may deliver an order to a user from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a particular retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The user client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which users can order items to be provided to them by a picker from a retailer. The online concierge system 140 receives orders from a user client device 100 through the network 130. The online concierge system 140 selects a picker to service the user's order and transmits the order to a picker client device 110 associated with the picker. The picker collects the ordered items from a retailer location and delivers the ordered items to the user via an attended delivery or unattended delivery. The online concierge system 140 may charge a user for the order and provide portions of the payment from the user to the picker and the retailer.

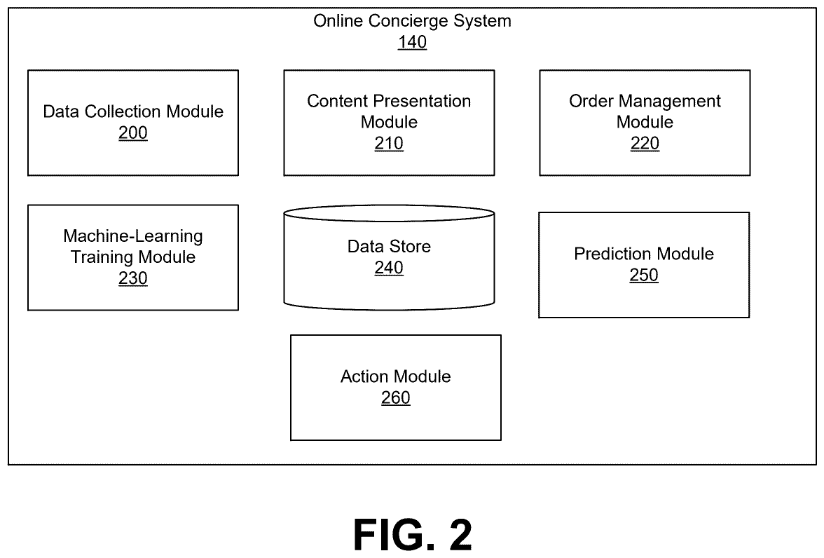

As an example, the online concierge system 140 may allow a user to order groceries from a grocery store retailer. The user's order may specify which groceries they want delivered from the grocery store and the quantities of each of the groceries as well as whether to deliver the order via attended delivery or unattended delivery. The user's client device 100 transmits the user's order to the online concierge system 140 and the online concierge system 140 selects a picker to travel to the grocery store retailer location to collect the groceries ordered by the user. Once the picker has collected the groceries ordered by the user, the picker delivers the groceries to a location transmitted to the picker client device 110 by the online concierge system 140 using the selected delivery option. The online concierge system 140 is described in further detail below with regards to FIG. 2.

FIG. 2 illustrates an example system architecture for an online concierge system 140, in accordance with some embodiments. The system architecture illustrated in FIG. 2 includes a data collection module 200, a content presentation module 210, an order management module 220, a machine-learning training module 230, a data store 240, a prediction module 250, and an action module 260. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, or stored payment instruments. The user data also may include default settings established by the user, such as a default retailer/retailer location, payment instrument, delivery location, or delivery timeframe. The user data may also include contact information for the user such as a telephone number or e-mail address and permission to contact the user via the contact information. The user data may also include contact information for another user that is associated with the user such as a friend or relative and permission to contact the other user. The data collection module 200 may collect the user data from sensors on the user client device 100 or based on the user's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the user client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online concierge system 140, a user rating for the picker, which retailers the picker has collected items at, or the picker's previous shopping history. Additionally, the picker data may include preferences expressed by the picker, such as their preferred retailers to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data (e.g., order attributes), which is information or data that describes characteristics of an order. For example, order data may include item data for items that are included in the order, a delivery location for the order, an estimated delivery time, a delivery type for the order (e.g., attended delivery or unattended delivery), a user associated with the order, a retailer location from which the user wants the ordered items collected, or a timeframe within which the user wants the order delivered. Order data may further include information describing how the order was serviced, such as which picker serviced the order, when (e.g., a time) the order was delivered, the type of delivery requested by the user (e.g., attended delivery or unattended), whether the requested type of delivery was successful or unsuccessful, or a rating that the user gave the delivery of the order. In some embodiments, the order data includes user data for users associated with the order, such as user data for a user who placed the order or picker data for a picker who serviced the order.

The content presentation module 210 selects content for presentation to a user. For example, the content presentation module 210 selects which items to present to a user while the user is placing an order. The content presentation module 210 generates and transmits an ordering interface for the user to order items which includes an option for the type of delivery (e.g., attended delivery or unattended delivery) requested by the user. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular retailer location. For example, the availability model may be trained to predict a likelihood that an item is available at a retailer location or may predict an estimated number of items that are available at a retailer location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from a user client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order or the picker's preferences for attended deliveries and/or unattended deliveries, the picker's ratings by users, or how often a picker agrees to service an order.

In some embodiments, the order management module 220 determines when to assign an order to a picker based on a delivery timeframe requested by the user with the order. The order management module 220 computes an estimated amount of time that it would take for a picker to collect the items for an order and deliver the ordered items to the delivery location for the order. The order management module 220 assigns the order to a picker at a time such that, if the picker immediately services the order, the picker is likely to deliver the order at a time within the requested timeframe using the type of delivery requested by the user. Thus, when the order management module 220 receives an order, the order management module 220 may delay in assigning the order to a picker if the requested timeframe is far enough in the future (i.e., the picker may be assigned at a later time and is still predicted to meet the requested timeframe).

When the order management module 220 assigns an order to a picker, the order management module 220 transmits the order to the picker client device 110 associated with the picker. The order received by the picker client device 110 may include an indication whether the order is to be delivered using an attended delivery or an unattended delivery. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit, to the picker client device 110, instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the user with the location of the picker so that the user can track the progress of the order. The order management module 220 may also transmit a notification(s) to the user related to an attended delivery that is predicted to be unsuccessful, as will be further described below. In some embodiments, the order management module 220 computes an estimated time of arrival of the picker at the delivery location and provides the estimated time of arrival to the user. In some embodiments, the order management module 220 tracks the time spent by the picker from arrival at the delivery location to departure of the delivery location for an attended delivery. The tracked time indicates the amount of time required to complete the attended delivery.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes a total cost for the order and charges the user that cost. The order management module 220 may provide a portion of the total cost to the picker for servicing the order, and another portion of the total cost to the retailer. In some embodiments, the portion of the total cost that is provided to the picker may be adjusted based on the amount of time required to complete an attended delivery. Pickers may be required to wait for a threshold amount of time (e.g., 10 minutes) to complete an attended delivery as part of the portion of the total cost received by the picker for servicing the order. In some embodiments, any additional time past the threshold amount of time that the picker stays at the delivery location to complete the attended delivery of the order results in an increase in the portion of the total cost received by the picker for servicing the order.

The machine-learning training module 230 trains machine-learning models used by the online concierge system 140. For example, the machine-learning training module 230 trains a prediction module 250 which is a machine-learned model to predict whether a user will be at a delivery location for an order at a delivery time to receive the order. Thus, the prediction module 250 is trained to predict whether an attended delivery of an order will be successful, as will be further described below. The online concierge system 140 may use machine-learning models to perform functionalities described herein. Example machine-learning models implemented by the prediction module 250 include regression models, support vector machines, naïve bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, or transformers. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model of the prediction module 250 based on a set of training examples stored in the data store 240. Each training example includes input data that is extracted from the training example to which the machine-learning model is applied to generate an output. For example, each training example is associated with a historical order in which a user selected the attended delivery option and may include user data, picker data, item data, or order data extracted from the training example. The features of the training examples used to train the prediction module 250 may be across all users of the online concierge system 140.

In some embodiments, features for a training example include user attributes of the user associated with the order in the training example. User attributes may include the amount of time for the user to receive the order from the picker after arrival of the picker to the delivery location, a delivery time range preference of the user, whether the user works from home, a classification of the delivery location of the user as being in a “safe” neighborhood where orders are rarely stolen or an “unsafe” neighborhood where orders are frequently stolen. In some embodiments, features of the training example may also include attributes of the order such as the time that the attended delivery was completed, distance from the location of the customer client device 100 to the delivery location at the time of order, distance from the location of the user's customer client device 100 to the delivery location at the time of delivery, whether the time of delivery of the order was within the estimated delivery time of the order (e.g., earlier or later than the estimated delivery time) for the order, whether the time of delivery of the order was within the delivery time range preference for the user, the retailer that supplies the items for the order, and/or whether the order included any special items such as perishable items or high cost items (e.g., above a threshold price).

In some embodiments, each training example also includes a label which represents whether the attended delivery of the order represented by the training example was successfully completed or was unsuccessful. For example, the training example may have a label of “1” to indicate that the order was successfully delivered using an attended delivery because the user was at the delivery location at the delivery time or may have a label of “0” to indicate that the order was delivered using an “unattended” delivery despite the user requesting an attended delivery due to the user not being at the delivery location at the delivery time. In these cases, the prediction module 250 is trained by comparing its output from input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train the machine-learning model of the prediction module 250 whereby the machine-learning training module 230 updates parameter values of the machine-learning model based on each of the set of training examples. The training examples may be processed together, individually, or in batches. To train the machine-learning model of the prediction module 250 based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label that is indicative of whether the attended delivery was successful or unsuccessful, the loss function is also based on the label for the training example. Some example loss functions include the mean square error function, the mean absolute error, hinge loss function, and the cross entropy loss function. The machine-learning training module 230 updates the set of parameters for the machine-learning model of the prediction module 250 based on the score generated by the loss function. For example, the machine-learning training module 230 may apply gradient descent to update the set of parameters.

In one or more embodiments, the machine-learning training module 230 may retrain the machine-learning model of the prediction module 250 based on the actual performance of the model after the online concierge system 140 has deployed the model to provide service to users. For example, the machine-learning model of the prediction module 250 is used to predict a likelihood that a user will be at a delivery location at a delivery time for an attended delivery (e.g., a successful attended delivery), the online concierge system 140 may log the prediction and an observation of the actual outcome of the event. After sufficient additional training data has been acquired, the machine-learning training module 230 re-trains the machine-learning model of the prediction module 250 using the additional training data, using any of the methods described above. This deployment and re-training process may be repeated over the lifetime use for the machine-learning model. This way, the machine-learning model continues to improve its output and adapts to changes in the system environment, thereby improving the functionality of the online concierge system 140 as a whole in its performance of the tasks described herein.

The data store 240 stores data used by the online concierge system 140. For example, the data store 240 stores user data, item data, order data, and picker data for use by the online concierge system 140. The data store 240 also stores trained machine-learning models trained by the machine-learning training module 230. For example, the data store 240 may store the set of parameters for a trained machine-learning model of the prediction module 250 on one or more non-transitory, computer-readable media and the training examples used to train the prediction module 250. The data store 240 uses computer-readable media to store data, and may use databases to organize the stored data.

In some embodiments, an order to be completed using an “attended” delivery is referred to as an attended delivery order. The prediction module 250 is trained by the machine-learning training module 230 to predict whether a user will be at a delivery location at a delivery time to receive an attended delivery order from a picker. That is, the prediction module 240 is trained by the machine learning module 230 to predict whether an attended delivery order will be successful or unsuccessful. The prediction module 250 generates the prediction by generating a likelihood that the user will be at the delivery location at the delivery time to receive the order from the picker. In some embodiments, the likelihood that the user will be at the delivery location at the delivery time is a prediction score that is between a value of “0” and “1”. The prediction module 250 compares the prediction score to a threshold value (e.g., 0.80), and a prediction score over the threshold value may indicate that the user will likely be at the delivery location at the delivery time to receive the order from the picker. Thus, the prediction module 250 predicts the attended delivery will be successful based on the prediction score being above the threshold value, for example. In contrast, a value below the threshold amount may indicate that the user will not be at the delivery location at the delivery time to receive the order from the picker. Thus, the prediction module 250 may predict that the attended delivery will be unsuccessful based on the prediction score being below the threshold value because the user will be at another location that is different from the delivery location at the delivery time.

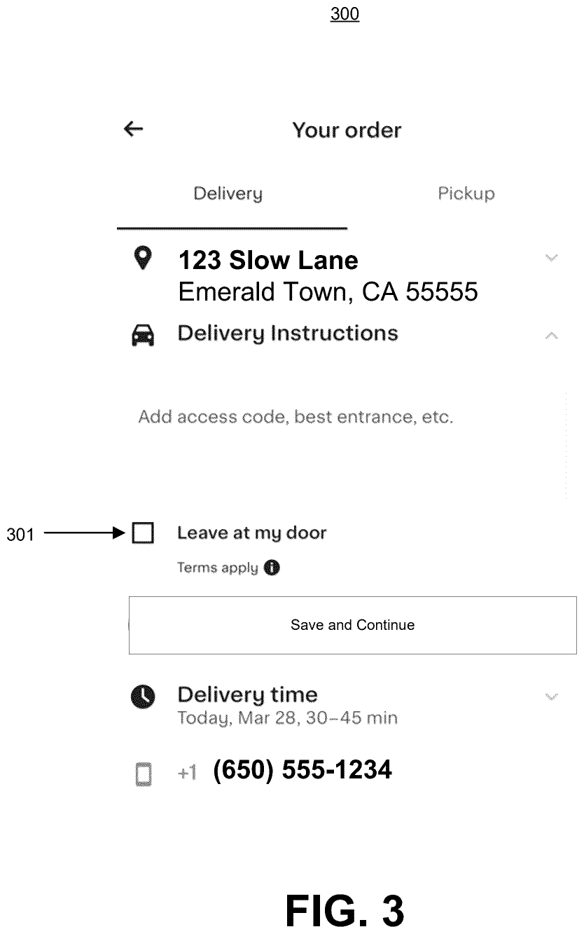

The prediction module 250 may predict whether the user will be at the delivery location at the delivery time one or more times at different time points from when items are added to the user's shopping list to delivery of the items at the delivery location. In some embodiments, the prediction module 250 may predict whether the user will be at the delivery location at the delivery time at the time the order is placed. For example, the prediction module 250 may predict whether the user will be at the delivery location at the delivery time after the user has added all the items to the user's shopping list and/or after payment for the items in the user's shopping list (e.g., before and/or after payment for the order). FIG. 3 is an example user interface 300 for selecting an unattended delivery or attended delivery for a user's order prior to the online concierge system 140 receiving payment for the user's order, in accordance with some embodiments. The user interface 300 includes a “leave at my door” option 301 signifying an unattended delivery request. By refraining from selecting option 301, the user thereby requests an attended delivery of the order. Responsive to the user selecting the attended delivery option, the prediction module 250 may predict whether the user will be at the delivery location at the delivery time. That is, the prediction module 250 predicts whether the attended delivery of the order will be successful or unsuccessful. The prediction module 250 may also predict whether the user will be at the delivery location at the delivery time responsive to the picker approaching the delivery location and/or the picker's arrival at the delivery location.

The prediction module 250 generates a prediction of whether the user will be at the delivery location at the delivery time by receiving as input order attributes of the attended delivery order. The order attributes may include the estimated delivery time for the order and attributes of each of the items included in the order such as the name of the item, the price of the item, a “high” price indicator if the price of the item is greater than a threshold (e.g., $100 threshold), the retailer that supplies the item, or an indication of whether the item is perishable. The order attributes may also include a categorization of the delivery location as being in a “safe” neighborhood. In some embodiments, a delivery location being categorized as a safe neighborhood indicates that theft of unattended deliveries in the neighborhood in which the delivery location is located is rare. Other order attributes may be input into the prediction module 250 than those described herein.

The prediction model 250 may also receive as input for each attended delivery order receives user attributes of the user that submitted the attended delivery order in addition to the order attributes. In some embodiments, the user attributes include historical data related to the user's historical attended delivery orders. A historical attended delivery order is a prior order of the user that was requested to be delivered using attended delivery by the user. The historical data is indicative of the user's historical behavior related to attended delivery orders.

In some embodiments, the historical data includes a success rate of historical attended delivery orders requested by the user. The success rate is indicative of whether the user's preference for attended deliveries is consistent or inconsistent with the customer's actual behavior related to the attended deliveries. For example, a “high” success rate (e.g., 80%) of successfully completed attended deliveries indicates that the customer's behavior is consistent with the preference for attended deliveries whereas a “low” success rate of (e.g., 50%) of successfully completed attended deliveries indicates that the customer's behavior is inconsistent with the preference for attended deliveries.

In some embodiments, the historical data may include for each of the user's historical attended delivery orders an amount of time taken by a picker to complete the historical attended delivery order after arrival of the picker to the delivery location. The historical data may also include the average amount of time required by pickers to complete all of the user's historical attended delivery orders after arrival of the pickers to the delivery locations. Thus, the historical data of the user is indicative of the user's responsiveness for attended delivery orders.

In some embodiments, the historical data may also include a delivery time range at which the user's historical attended delivery orders were successfully completed as the user was at the delivery locations at the delivery times for the historical attended delivery orders as well as a time range at which the user's historical attended delivery orders were unsuccessfully completed as the user was not at the delivery locations at the delivery locations. For example, the historical data for the user may indicate that between 4 PM to 8 PM attended delivery orders were typically successful for the user whereas between 9 AM to 3 PM attended delivery orders were unsuccessful for the user.

In some embodiments, the user attributes may also include the user's preferred delivery time range. The user attributes may also include a current location of the user. The user's current location may be received one or more times for the attended delivery order. For example, the user's location may be received at the time the order is placed as well, as the picker is approaching the delivery location, and/or when the picker arrives at the delivery location. In some embodiments, the user attributes also include a categorization of the user that indicates whether the attended delivery order can be switched to an unattended delivery order instead of having the picker wait the threshold amount of time for the user to receive the order. The categorization may indicate that the user works from home (WFH), that the user is a stay at home parent (SAHP), or that the user is a party prepper, for example. Having one of the above categorizations is an indication that is likely safe to leave the order unattended.

Responsive to receiving the order attributes and the user attributes of the attended delivery order, the prediction module 250 outputs a prediction of whether the user will be at the delivery location at the delivery time. As mentioned above, the prediction is a score that is compared to a threshold value. A score above the threshold value indicates that the attended delivery will likely be successful as the user will be at the delivery location at the delivery time to receive the order from the picker in person whereas a score below the threshold value indicates the attended delivery will likely be unsuccessful as the user will not be at the delivery location at the delivery time to receive the order from the picker in person. Based on the prediction, a remedial action may be performed by the action module 260.

Responsive to the prediction by the prediction module 250 indicating that the user is likely to be at the delivery location at the delivery time, no action is taken by the action module 260. In some embodiments, the action module 260 performs one or more remedial actions responsive to the prediction module 250 predicting that the attended delivery will be unsuccessful because the user will not be at the delivery location at the delivery time. Remedial actions may either increase a likelihood of a success of the attended delivery or may reduce a risk posed to the picker to complete the attended delivery, for example.

The action module 260 may perform the remedial action each time the prediction module 250 predicts that the user will not be at the delivery location at the delivery time thereby resulting in an unsuccessful attended delivery. For example, the remedial action may be performed at the time when the attended delivery option is selected (FIG. 3), after the online concierge system 140 receives the payment for the user's order, as the picker is approaching the delivery location, and/or responsive to the picker arriving at the delivery location.

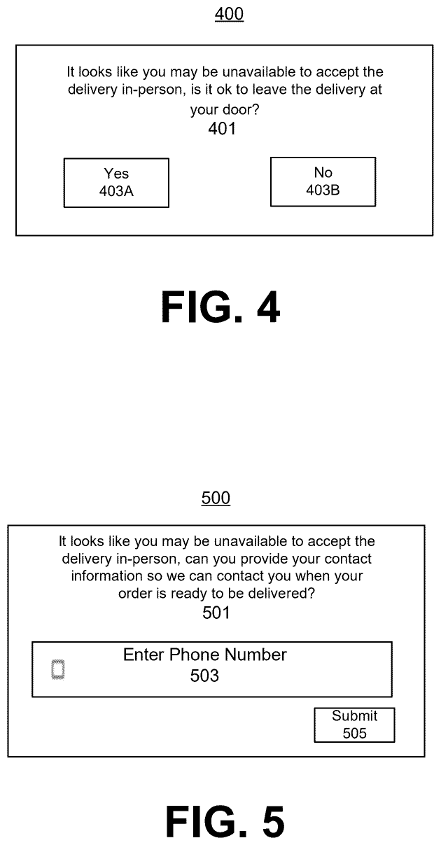

An example of a remedial action performed by the action module 260 to increase the likelihood that the user will be at the delivery location at the delivery time thereby resulting in a successful attended delivery includes transmitting notification to the customer client device 100 of the user requesting to switch the order from an attended delivery to an unattended delivery. FIG. 4 is an example user interface 400 that is transmitted to the customer client device 100 responsive to the prediction that the user will not be at the delivery location at the delivery time (e.g., an unsuccessful attended delivery). The user interface 400 includes a prompt 401 including text requesting to change the delivery to an unattended delivery and selection mechanisms 403 to either accept or deny the request. For example, the user interface 400 includes a first selection mechanism 403A for accepting the request to change the delivery to an unattended delivery or a second selection mechanism 403B for declining the request to change the delivery to an unattended delivery.

The user denying the request to change the order to the unattended delivery implies that the user is confirming that the user will be available to receive the order from the picker in-person at the delivery location. Thus, providing the user interface 400 increases a likelihood that the attended delivery will be successfully completed. The order management module 220 will update the order accordingly based on the user's selection. Responsive to the user accepting the suggestion to change the delivery to an unattended delivery, the order management module 220 may transmit a notification to the picker client device 110 of the picker that the delivery was changed from an attended delivery to an unattended delivery.

In some embodiments, the user interface 300 shown in FIG. 3 is revised to remove the “leave at my door” option 301 that signifies an unattended delivery request. The option 301 is removed responsive to a high confidence that the user will be unavailable for the unattended delivery whereas if there is a lower, but still high confidence that the user will not be available, the user is prompted to change the delivery option as shown in FIG. 4.

In some embodiments, a remedial action performed by the action module 260 to increase the likelihood that the user will be at the delivery location at the delivery time includes transmitting a notification to the customer client device 100 of the user that requests for the user to provide the user's contact information. The picker may use the requested contact information to contact the user as the picker is approaching the delivery location and/or while the picker is at the delivery location.

FIG. 5 is an example user interface 500 that is transmitted to the customer client device 100 responsive to a prediction that the user will not be at the delivery location at the delivery time (e.g., an unsuccessful attended delivery). The user interface 500 includes a prompt 501 that requests for the user to provide the user's contact information. The user interface 500 includes a text box 503 through which the user provides the contact information such as a telephone number and a user interface element 505 to submit the contact information to the online concierge system 140. Submission of the contact information grants the online concierge system 140 permission to contact the user via the contact information. Responsive to receiving the contact information, the order management module 220 updates the order with the contact information and transmits a notification that includes the user's contact information to the picker client device 110 of the picker. In some embodiments, the user's contact information that is included in the notification is obfuscated so that the picker cannot determine the user's contact information from the notification. However, the picker can still contact the user by selecting the obfuscated contact information.

Another example of a remedial action performed by the action module 260 to increase the likelihood that the user will be at the delivery location at the delivery time includes transmitting a notification to the customer client device 100 of the user to provide another user's contact information to be used by the picker upon delivery. Since the prediction module 250 predicts that the attended delivery will be unsuccessful, the online concierge system 140 attempts to increase the success of the attended delivery by obtaining contact information of another user that can receive the order at the delivery location on behalf of the user that submitted the order.

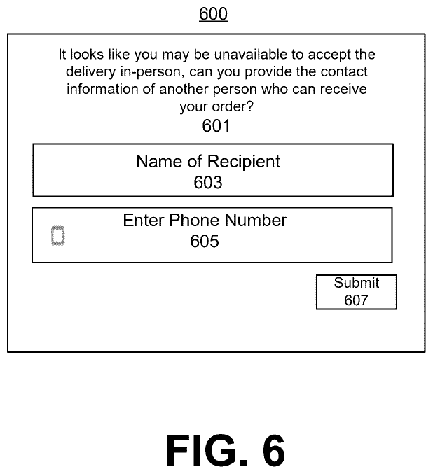

FIG. 6 is an example user interface 600 that is transmitted to the customer client device 100 responsive to a prediction that the user will not be at the delivery location at the delivery time (e.g., an unsuccessful attended delivery). The user interface 500 includes a prompt 601 for the user to provide another user's contact information to be used by the picker because the user that submitted the order may be unavailable to receive the order from the picker in person at the delivery location. The user interface 600 includes a text box 603 through which the user provides the name of the other user who will receive the order at the delivery location from the picker on behalf of the user, a text box 603 through which the user provides the contact information of the other user such as a telephone number, and a user interface element 607 to submit the contact information to the online concierge system 140. By submitting the contact information of the other user, the user grants the online concierge system 140 permission to contact the other user for the order. Responsive to receiving the contact information of the other user, the order management module 220 updates the order with the name and contact information of the other user that will receive the order on behalf of the user and may transmit a notification that includes the other user's contact information to the picker client device 110 of the picker. In some embodiments, the other user's contact information is obfuscated so that the picker cannot determine the other user's contact information from the notification. However, the picker can still contact the other user by selecting the obfuscated contact information.

In some embodiments, the action module 260 may also perform a remedial action that decreases a risk to the picker posed by the attended delivery option responsive to the prediction module 250 predicting that the user will not be at the delivery location at the delivery time (e.g., an unsuccessful attended delivery). For example, the action module 260 may automatically change the attended delivery order to an unattended delivery order without consent from the user based on an estimated time of delivery.

In some embodiments, the action module 260 may change the order to an unattended delivery order based on time responsive to the prediction module 250 predicting that the user will not be at the delivery location at the delivery time. For example, the action module 250 changes the order to an unattended delivery responsive to the estimated time of delivery of the order being after a time corresponding to sundown (e.g., at night). The order management module 220 may update the order to be an unattended delivery and may transmit a notification to the picker client device 110 of the picker of the change from the attended delivery to the unattended delivery.

In some embodiments, the action module 260 may automatically change the attended delivery order to an unattended delivery order without consent from the user based on the location of the delivery location. As mentioned previously, a neighborhood may be classified as a “safe” neighborhood. Responsive to the delivery location being in a neighborhood designated as a “safe” neighborhood and the prediction module 250 predicting that the user will not be at the delivery location at the delivery time, the action module 260 may automatically change the attended delivery order to an unattended delivery order given the order is unlikely to be stolen if the order is left unattended at the delivery location. The order management module 220 may update the order to be an unattended delivery and may transmit a notification to the picker client device 110 of the picker of the change from the attended delivery to the unattended delivery.

In some embodiments, the action module 260 may perform multiple remedial actions responsive to the prediction module 250 predicting that the user will not be at the delivery location at the delivery time. For example, the action module 260 may first transmit the notification to the customer client device 100 of the user that submitted the order to switch the order from an attended delivery to an unattended delivery as shown in FIG. 4. Responsive to the user declining to switch to the unattended delivery, the action module 260 may transmit the notification to the customer client device 100 of the user to provide the user's contact information to be used by the picker upon delivery as shown upon FIG. 5. Alternatively, responsive to the user declining to switch to the unattended delivery, the action module 260 may transmit the notification to the customer client device 100 of the user to provide another user's contact information to be used by the picker upon delivery as shown in FIG. 6.

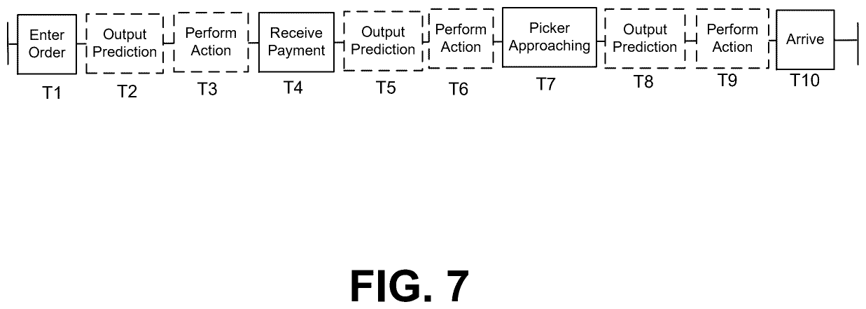

As mentioned previously, the prediction module 250 and action module 260 may respectively predict whether the user will be at the delivery location at the delivery time and perform a remedial action responsive to a prediction that the user will not be at the delivery location at the delivery time multiple times between the order submission to delivery of the order. FIG. 7 is a diagram illustrating a timeline for delivering a user's order, in accordance with one or more embodiments.

At time T1, a user may enter an attended delivery order in a shopping list that lists items included in the order as well as a selection of an attended delivery option. At time T2 following the entry of the attended delivery order, the prediction module 250 outputs a first prediction of success of the attended delivery order. The first prediction may indicate that the user will not be at the delivery location at the delivery time (e.g., an unsuccessful attended delivery). Accordingly, the action module 260 performs a first remedial action at time T3 responsive to the first prediction that the user will not be at the delivery location at the delivery time. The first remedial action may include one or more of requesting for the user to switch the attended delivery order to an unattended delivery order, requesting contact information of the user, requesting contact information of another user that can receive the order, and/or automatically switching the order to an unattended delivery order. The online concierge system 140 transmits the appropriate notification to the picker client device 110 at time T3 if any change to the order is made such as a switch to the unattended delivery or receipt of contact information.

At time T4, payment for the order is received by the online concierge system 140. That is, the user pays for the attended delivery order. At time T5, the prediction module 250 outputs a second prediction of a success of the attended delivery order. The second prediction may still indicate that the user will not be at the delivery location at the delivery time. Accordingly, the action module 260 performs a second remedial action at time T6 responsive to the second prediction being an unsuccessful attended delivery. The second remedial action may include one or more of requesting for the user to switch the attended delivery order to an unattended delivery order, requesting contact information of the user, requesting contact information of another user that can receive the order, and/or automatically switching the order to an unattended delivery order. The online concierge system 140 transmits the appropriate notification to the picker client device 110 at time T6 if any change to the order is made such as a switch to the unattended delivery or receipt of contact information.

At time T7, the picker is approaching the delivery location with the user's order for attended delivery. At time T8, the prediction module 250 outputs a third prediction of a success of the attended delivery order. The third prediction may still indicate that the user will not be at the delivery location at the delivery time. Accordingly, the action module 260 performs a third remedial action at time T9 responsive to the third prediction being an unsuccessful attended delivery. The third remedial action may include one or more of requesting for the user to switch the attended delivery order to an unattended delivery order, requesting contact information of the user, requesting contact information of another user that can receive the order, and/or automatically switching the order to an unattended delivery order. The online concierge system 140 transmits the appropriate notification to the picker client device 110 at time T9 if any change to the order is made such as a switch to the unattended delivery or receipt of contact information.

At time T10, the picker arrives at the delivery location during which the picker may attempt the attended delivery of the order. The order may be delivered successfully due to the remedial actions that were performed by the action module 260. For example, the picker may use the contact information of the user or another user to complete the attended delivery of the order. Alternatively, the picker may leave the order at the delivery location unattended based on the remedial action performed by the action module 260.

As shown in FIG. 7, the prediction and remedial actions are performed three times. However, the online concierge system 140 may perform the prediction fewer or more times than shown in FIG. 7. For example, the prediction and subsequent remedial actions may only be performed after payment receipt at times T5 and T6 and after the picker is approaching the delivery location at times T8 and T9. In another example, the prediction and subsequent remedial actions may only be performed once between time T1 and time T10. Due to the remedial actions that are performed responsive to predictions of unsuccessful attended deliveries, pickers are relieved from the burden of having to make a decision during delivery whether to leave the order unattended upon arrival at the delivery location or wait for the user to complete the attended delivery.

In some embodiments, the number of times that the concierge system 140 may perform the prediction is dynamically selected based on the user. For example, the concierge system 140 may perform the prediction more for a user that has been unreliable in attended delivery orders based on feedback from previous attended delivery orders of the user compared to another user that has been reliable in attended delivery orders based on feedback from previous attended deliveries of the other user.

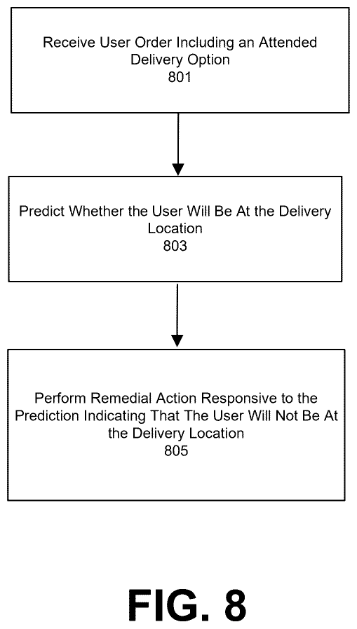

FIG. 8 is a flowchart for a method of delivering a user's order, in accordance with some embodiments. Alternative embodiments may include more, fewer, or different steps from those illustrated in FIG. 8 and the steps may be performed in a different order from that illustrated in FIG. 8. These steps may be performed by an online concierge system (e.g., online concierge system 140). Additionally, each of these steps may be performed automatically by the online concierge system without human intervention.

The online concierge system 140 receives 801 a user order. The user order includes a list of items ordered from a customer client device 100 of a user. The order also includes an indication that the user has selected the delivery option of an “attended” delivery. Thus, a delivery agent will deliver the order to the user such that the user is physically present to receive the order from the delivery agent when the delivery agent arrives at the delivery location at the delivery time to deliver the order.

The online concierge system 140 predicts 803 whether the user will be at the delivery location at the delivery time. Thus, the online concierge system 140 predicts whether the attended delivery will be successful. The online concierge system 140 generates the prediction by inputting order attributes of the order and user attributes of the user that submitted the order to a trained machine-learned model of the online concierge system 140. The online concierge system 140 outputs a prediction score that indicates a likelihood that the user will be at the delivery location at the delivery time for the attended delivery based on the inputted order attributes and user attributes. The online concierge system 140 compares the prediction score to a threshold value and determines the prediction of whether the user will be at the delivery location at the time of the attended delivery based on the comparison.

The online concierge system 140 performs 805 a remedial action responsive to the prediction indicating that the user will not be at the delivery location at the delivery time. The remedial action may be one or more different actions related to the attended delivery such as transmitting a notification to the customer client device 100 of the user that increases a likelihood that the user will be at the delivery location at the delivery time for the attended delivery or reduce risk to the picker. For example, the online concierge system 140 may transmit a notification to the user to provide contact information through which the picker may contact the user when the order is ready to be delivered. The online concierge 140 may alternatively or in addition to transmit a notification to the user to provide contact information of another user that the picker may contact when the order is ready to be delivered. In another example, the online concierge system 140 may transmit a notification to the user recommending switching the attended delivery to an unattended delivery. An example of a remedial action to reduce the risk to the picker is automatically changing the delivery to an unattended delivery due to the online concierge system 140 predicting that the attended delivery will be unsuccessful and the estimated time of delivery being at night and/or in an unsafe neighborhood, for example.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated for the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed at a computer system, comprising a processor and a computer-readable medium, the method comprising:
receiving an order from a client device of a user, the order including a list of items, a delivery location, a delivery time of the order at the delivery location, and a request by the user for an attended delivery of the order where the user will be at the delivery location at the delivery time to receive the order from a delivery agent;
predicting, by a machine-learned model, a likelihood that is indicative of whether the user will be at the delivery location during the delivery time based on user attributes of the user and order attributes of the order that are input into the machine-learned model;
comparing the likelihood predicted by the machine-learned model to a threshold value; and
performing a remedial action including transmitting a notification to the client device of the user to provide additional instructions for the attended delivery responsive to the likelihood being below the threshold value based on the comparison.

2. The method of claim 1, wherein performing the remedial action comprises:
transmitting the notification to the client device of the user that includes a request for contact information of the user;
receiving the requested contact information of the user from the client device of the user; and
providing the contact information to a client device of the delivery agent.

3. The method of claim 1, wherein performing the remedial action comprises:
transmitting the notification to the client device of the user that includes a request for contact information of another user that will be present at the delivery location to receive the order from the delivery agent at the delivery time;
receiving the requested contact information of the other user from the client device of the user; and
providing the contact information of the other user to a client device of the delivery agent.

4. The method of claim 1, wherein performing the remedial action comprises:
transmitting the notification to the client device of the user requesting approval to change the attended delivery of the order to an unattended delivery of the order where the delivery agent leaves the order at the delivery location at the delivery time without the user being at the delivery location at the delivery time to receive the order from the delivery agent.

5. The method of claim 4, wherein transmitting the notification comprises:
receiving a decline of the request to change the attended delivery of the order from the client device of the user, the decline of the request confirming that the user will be at the delivery location at the delivery time to receive the order from the delivery agent.

6. The method of claim 4, wherein transmitting the notification comprises:
receiving an approval of the request to change the attended delivery of the order to the unattended delivery of the order from the client device of the user; and
transmitting a notification to a client device of the delivery agent that indicates a change from the attended delivery of the order to the unattended delivery of the order.

7. The method of claim 1, wherein the machine-learned model predicts whether the user will be at the delivery location at the delivery time a plurality of times from when the order is received to delivery of the order at the delivery location,
wherein a number of times that the machine-learned model predicts whether the user will be at the delivery time is selected based on the user.

8. The method of claim 7, wherein the machine-learned model predicts whether the user will be at the delivery location at the delivery time at least during one of the user completing an entry of the list of items on the client device of the user, after payment for the list of items on the client device, or responsive to the delivery agent approaching the delivery location.

9. The method of claim 8, further comprising:
identifying that the delivery agent is approaching the delivery location,
wherein the machine-learned model predicts whether the user will be the delivery location at the delivery time responsive to determining that the delivery agent is approaching the delivery location.

10. The method of claim 9, wherein predicting whether the user will be at the delivery location at the delivery time responsive to identifying that the delivery agent is approaching the delivery location comprises:
identifying a location of the client device of the user is different from the delivery location as the delivery agent is approaching the delivery location;
inputting the location of the client device of the user to the machine-learned model in addition to the user attributes of the user and the order attributes, the machine-learned model predicting that the user is not likely to be at the delivery location at the delivery time based on the location of the client device, the user attributes, and the order attributes;
automatically changing the attended delivery of the order to an unattended delivery of the order where the delivery agent leaves the order at the delivery location without the user being at the delivery location; and
transmitting a notification to a client device of the delivery agent that indicates the change from the attended delivery of the order to the unattended delivery of the order.

11. The method of claim 9, wherein predicting whether the user will be at the delivery location at the delivery time responsive to determining that the delivery agent is approaching the delivery location comprises:
identifying that the delivery location of the order is within an area that is safe to leave the order unattended responsive to machine-learned model predicting that the user is not likely to be at the delivery location at the delivery time;
automatically changing the attended delivery of the order to an unattended delivery of the order where the delivery agent leaves the order at the delivery location without the user being at the delivery location; and
transmitting a notification to a client device of the delivery agent that indicates the change from the attended delivery of the order to the unattended delivery of the order.

12. The method of claim 9, wherein predicting whether the user will be at the delivery location at the delivery time responsive to determining that the delivery agent is approaching the delivery location comprises:
identifying the delivery time at which the attended delivery of the order is to be completed responsive to the likelihood being below the threshold value;
identifying that it is unsafe for the delivery agent to complete the attended delivery of the order based on the delivery time;
automatically changing the attended delivery of the order to an unattended delivery of the order where the delivery agent leaves the order at the delivery location without the user being present; and
transmitting a notification to a client device of the delivery agent that indicates the change from the attended delivery of the order to the unattended delivery of the order.

13. The method of claim 1, wherein predicting the likelihood comprises:
inputting the user attributes into the machine-learned model, the user attributes including historical data of the user's historical orders that were requested by the user to be delivered using attended delivery,
wherein the historical data is indicative of a behavior of the user during the attended delivery of the user's historical orders.

14. The method of claim 13, wherein the historical data includes at least one of a success rate of the user's historical orders being delivered using the attended delivery, an amount of time taken by a historical delivery agent to deliver each of the user's historical orders after arrival by the historical delivery agent to a historical delivery location specified by the user, or an average amount of time taken by historical delivery agents to deliver the user's historical orders after arrival of the historical delivery agents to historical delivery locations specified by the user for the user's historical orders.

15. The method of claim 13, wherein predicting the likelihood comprises:
inputting the order attributes into the machine-learned model, the order attributes including the delivery time for the delivery and attributes of each item in the list,
wherein the attributes for each item include a name of the time, a price of the item, an indicator that the price of the item is greater than a threshold, a retailer that supplies the item, and an indication of whether the item is perishable.

16. The method of claim 1, further comprising:
storing a set of training examples associated with a plurality of different users, each training example is an historical order that was requested to be delivered as an attended delivery by a corresponding one of the plurality of different users and a label indicating whether one of the corresponding user that requested the historical order was at a historical delivery location during the attended delivery of the historical order and the one of the corresponding user was not at the historical delivery location during the attended delivery; and
training the machine-learned model by adjusting parameters of the machine-learned model using the set of training examples.

17. The method of claim 16, further comprising:
retraining the machine-learned model by adjusting the parameters of the machine-learned model responsive to the user being at the delivery location at the delivery time or the user not being at the delivery location at the delivery time.

18. A non-transitory computer readable storage medium comprising stored program code instructions, the instructions when executed causes a processing system to:
receive an order from a client device of a user, the order including a list of items, a delivery location, a delivery time of the order at the delivery location, and a request by the user for an attended delivery of the order where the user will be at the delivery location at the delivery time to receive the order from a delivery agent;
predict, by a machine-learned model, a likelihood that is indicative of whether the user will be at the delivery location during the delivery time based on user attributes of the user and order attributes of the order that are input into the machine-learned model; and
compare the likelihood predicted by the machine-learned model to a threshold value; and
perform a remedial action including transmitting a notification to the client device of the user to provide additional instructions for the attended delivery responsive to the likelihood being below the threshold value based on the comparison.

19. The non-transitory computer readable storage medium of claim 18, wherein performing the remedial action comprises:
transmitting the notification to the client device of the user that includes at least one of a request for contact information of the user, a request for contact information of another user that will be present at the delivery location to receive the order from the delivery agent at the delivery time, or approval to change the attended delivery of the order to an unattended delivery of the order where the delivery agent leaves the order at the delivery location at the delivery time without the user being at the delivery location at the delivery time to receive the order from the delivery agent; and
receiving at least one of the requested contact information of the user, the requested contact information of the other user, or a decline of the approval to change the attended delivery of the order to the unattended delivery of the order from the client device of the user.

20. A computer system comprising:
a processor; and
a non-transitory computer-readable medium storing instructions that, when executed by the processor, cause the processor to:
receive an order from a client device of a user, the order including a list of items, a delivery location, a delivery time of the order at the delivery location, and a request by the user for an attended delivery of the order where the user will be at the delivery location at the delivery time to receive the order from a delivery agent;
predict, by a machine-learned model, a likelihood that is indicative of whether the user will be at the delivery location during the delivery time based on user attributes of the user and order attributes of the order that are input into the machine-learned model; and
compare the likelihood predicted by the machine-learned model to a threshold value; and
perform a remedial action including transmitting a notification to the client device of the user to provide additional instructions for the attended delivery responsive to the likelihood being below the threshold value based on the comparison.
